(19) United States
(12) Patent Application Publication
(10) Pub. No.: US 2024/0402091 A1
(43) Pub. Date: Dec. 5, 2024

(54) COLORMETRIC METHODS TO PREDICT COATING AND BOND PERFORMANCE PROPERTIES

(71) Applicant: The Boeing Company, Arlington, VA (US)

(72) Inventor: Eileen Olga KUTSCHA, Seattle, WA (US)

(73) Assignee: The Boeing Company, Arlington, VA (US)

(21) Appl. No.: 18/326,507

(22) Filed: May 31, 2023

(51) Int. Cl. G01N 21/84; G01N 17/00

(52) U.S. Cl. CPC G01N 21/8422; G01N 17/00; G01N 2021/8427

(57) ABSTRACT

A method for measuring performance of a film coated onto a substrate is disclosed, including exposing a coated substrate to a corrosive environment, evaluating the coated substrate using colorimetric analysis, quantifying the colorimetric analysis. The method also includes determining a coating performance attributes, corrosion resistance and bond strength, based on the colorimetric analysis. Also disclosed is a method of applying a coating to a substrate, including applying a primer to a surface of a substrate, curing the primer at an elevated temperature, and measuring a surface of the primer coated substrate with a spectrometer.

### TECHNICAL FIELD

The present teachings relate generally to colorimetric methods for predicting coating properties and bond strength and, more particularly, to prediction of coating and bond strength properties related to aerospace structures.

### BACKGROUND

Structural adhesive bond primers are typically used for bonding metallic aerospace parts. The adhesive bond primer is applied to the substrate, such as anodized aluminum, and can protect a substrate between anodization and bonding. Once a substrate is anodized, the anodized surface can be delicate and prone to potential physical damage. In examples, the thickness of structural adhesive bond primer applied has an effect on bond performance and corrosion resistance. The adhesive bond primer also acts as a component of the bond between the anodized metallic substrate and the subsequent epoxy film adhesive.

Detection of the bond primer thickness can be difficult to ascertain due to the very thin target thickness of below 0.50 mil. Thickness detection can be limited by a lack of sensitivity of primer thickness measurement devices and/or the ability of the trained operator to detect the thickness visually over various substrates.

Therefore, it is desirable to develop a method for prediction of corrosion inhibition properties and bond performance of an organic epoxy adhesive promoting film on substrates for aerospace components.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method for measuring performance of a film coated onto a substrate is disclosed. The method for measuring performance of a film coated onto a substrate includes exposing a coated substrate to a corrosive environment, evaluating the coated substrate using colorimetric analysis, quantifying the colorimetric analysis. The method also includes determining a coating performance attributes, corrosion resistance and bond strength, based on the colorimetric analysis.

Implementations of the method for measuring performance of a film coated onto a substrate can include where the corrosive environment may include salt and moisture. The coating can include an epoxy-functional paint or resin. The substrate can include a metal. The colorimetric analysis may include the use of an L*a*b* color scale. The method for measuring performance of a film coated onto a substrate may include treating the substrate prior to coating the substrate. Treating the substrate may include an anodization process. Treating the substrate may include applying a primer may include an epoxy. A thickness range of primer is from 0.1 mil to 0.5 mil. The primer may include hexavalent chromium. The primer may include a dye. The coating may include an epoxy-functional paint or resin.

Also disclosed is a method of applying a coating to a substrate. The method includes applying a primer to a surface of a substrate, curing the primer at an elevated temperature, and measuring a surface of the primer coated substrate with a spectrometer. The method also includes evaluating the coated substrate using colorimetric analysis. Implementations of the method of applying a coating to a substrate may include applying an overcoat onto the primer. The method of applying a coating to a substrate may include bonding a substrate having a primer applied to another surface. The method of applying a coating to a substrate may include exposing the coated substrate to a corrosive environment. The method of applying a coating to a substrate may include quantifying the colorimetric analysis, and determining a coating performance attribute based on the colorimetric analysis. The colorimetric analysis may include the use of an L*a*b* color scale. A thickness range of primer is from 0.1 mil to 0.5 mil. The overcoat may include an epoxy-functional paint or resin.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic depicting a bonded joint between two components, in accordance with the present disclosure.

FIG. 2 is a schematic depicting color space in accordance with a CIELab coordinate system, highlighting a specific color example, in accordance with the present disclosure.

FIG. 3 is a plot depicting measurements of a b* color value as a function of bond primer thickness, in accordance with the present disclosure.

FIG. 4 is a plot depicting corrosion resistance rating as a function of primer type and primer thickness, in accordance with the present disclosure.

FIG. 5 is a schematic of an adhesive test setup, in accordance with the present disclosure.

FIGS. 6A-6C, is a series of plots depicting a correlation between bond strength rating and primer thickness, in accordance with the present disclosure.

FIGS. 7A-7C, is a series of plots depicting a correlation between b* color value of chromium free bond primer and bond peel strength value with three different adhesives, in accordance with the present disclosure.

FIG. 8 is a flowchart illustrating a method for measuring performance of a film coated onto a substrate, in accordance with the present disclosure.

FIG. 9 is a flowchart illustrating a method of applying a coating to a substrate, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present disclosure encompasses the prediction of corrosion inhibition properties and bond performance of an organic epoxy adhesive promoting film on metal based on the colorimetric values of the bond primer. This measurement method and coating application method can provide a predictive bond performance of a subsequently bonded joint through the detection of bond primer thickness using a colorimetric method.

The color values of a bond primer can provide an indication of the thickness of an adhesive bond primer, which results in improved corrosion inhibiting properties of the coating and/or subsequent bonded joint performance while in service. This predictive tool and method of coating application enables more robust and reliable bonded aerospace structures by verifying bond primer thickness as well as corrosion inhibiting properties outside the bondline.

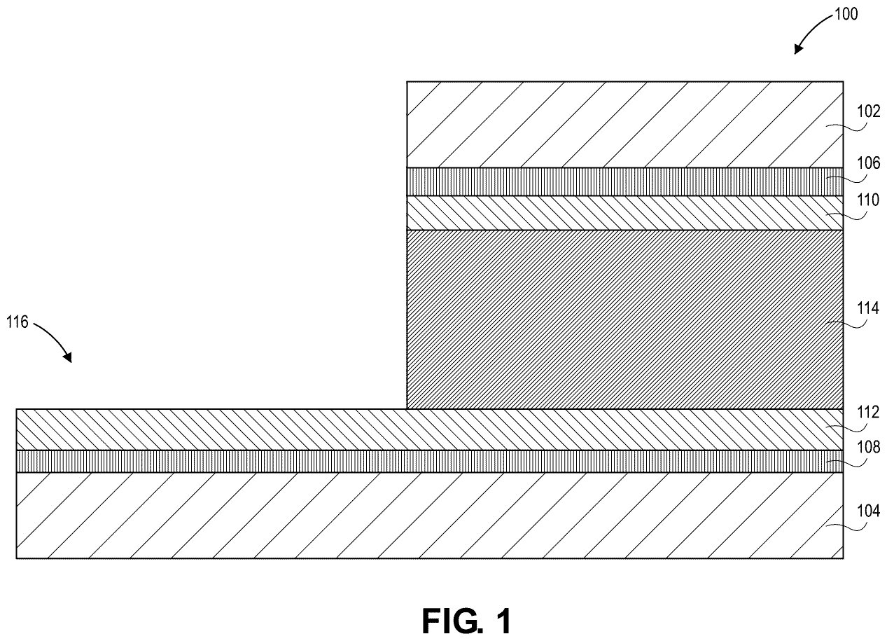

A bonded joint 100 includes two aluminum substrates 102, 104 each having an anodized surface 106, 108, each coated with an epoxy adhesive bond primer 110, 112 that are joined together with an epoxy film adhesive 114. An example of the bonded joint of the components or substrates 102, 104 as well as the area outside 116 the bonded joint that is still coated with primer 110 is shown in FIG. 1. The epoxy adhesive bond primer 110, 112 coating thickness is measured prior to bonding and is a predictive indication of bond performance after the epoxy adhesive bond primer 110, 112 coating is incorporated into the bonded joint 100.

Structural adhesive bond primers are typically used for bonding metallic aerospace parts. The primer is applied to a substrate, such as, but not limited to, an anodized aluminum substrate and protects this delicate anodize surface from damage between anodization and bonding. The thickness of structural adhesive bond primer applied can influence bond performance and corrosion resistance, among other coating properties that could be impacted by coating thickness including chemical resistance.

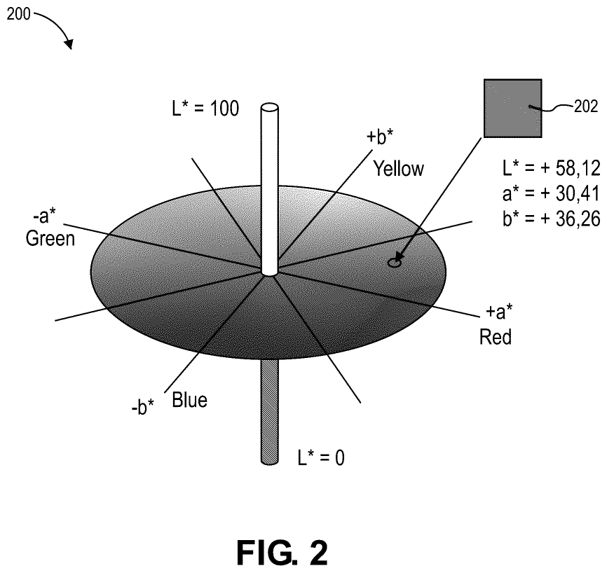

FIG. 2 is a schematic depicting color space in accordance with a CIELab coordinate system, highlighting a specific color example, in accordance with the present disclosure. In one example, one or more colorimetric values can provide an indication of bond performance by correlation of structural bond primer thickness to a CIE b* (blue/yellow) color value. In other examples, different CIE values can be used to predict coating properties, such as an a* value, a b* value, an L* value, or a combination thereof. Likewise, these values could be positive or negative.

The CIE (Commission Internationale de l'Eclairage) color standard is a known international standard for measuring and describing color. The CIE standard is based a trichromatic theory of color vision, based on the three primary colors of red, green, and blue. The CIE color space is a three-dimensional space that represents all colors visible to the human eye. The three axes of the color space represent the three primary colors, with each point in the space representing a unique color. The CIE color space can be utilized to define standard color models such as RGB, CMYK, and LAB.

A variety of measurement instruments, such as colorimeters and spectrophotometers, can be used to measure the color of an object using the CIE color standard. These instruments measure the reflectance or transmittance of light from the surface of an object and provide numerical values that represent the detected color. The CIE also developed a standard illuminant, which is a standardized light source used for color measurement. The CIE standard further uses a standard illuminant, a theoretical light source that represents average daylight that can be used as a reference for color measurement.

RGB designates red, green, and/or blue, and denotes an additive color model which can be used for displaying colors on electronic displays such as computer screens, televisions, mobile phones, and the like. In the RGB color model, colors are created by mixing varying amounts of red, green, and blue light. This additive color theory provides for situations where different colors of light are added together to produce a new color. The RGB color model can also be used for digital design, photography, and video editing.

CMYK is a designation for a cyan, magenta, yellow, and key (black) color model, and is a subtractive color model most commonly used for printing purposes. In the CMYK color model, colors are created by subtracting varying amounts of cyan, magenta, yellow, and black inks from a white substrate. This subtractive color theory dictates that different colors of ink are subtracted from white to produce a new color. In addition to its use in printing, the CMYK color model can be used in applications such as, but not limited to newspapers, magazines, and packaging.

The LAB color model 200, as shown in FIG. 2, can be used for color management and colorimetry. The LAB color model is a device-independent color model capable of representing all colors visible to the human eye. The LAB color model 200 is based on the CIE color space, and it defines colors in terms of lightness (L), position between red and green (a), and position between yellow and blue (b). The CIE L*a*b* color scale can be used in the present disclosure to quantify the color values of adhesive materials and processes. L is an indication of the gray scale where 0 is black and 100 is white, a is an indication of the red (positive values)-green (negative values) color scale and b is an indication of the yellow (positive values)-blue (negative values) color scale. The LAB color model 200 can be used in color matching, color correction, and color reproduction applications in various industries such as printing, textiles, and paint manufacturing, color monitoring, and the like. A representative value 202 in the LAB color space with corresponding L*, a*, and b* values noted is shown in FIG. 2.

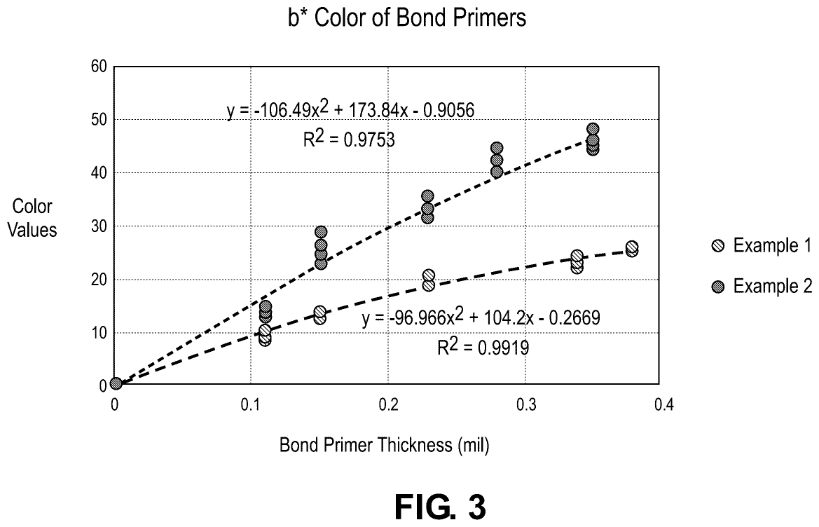

FIG. 3 is a plot depicting measurements of a b* color value as a function of bond primer thickness, in accordance with the present disclosure. For examples of bond primers, applied at various thickness levels, color values were measured and determined with the use of a colorimeter. Materials used in experiments of the present disclosure include substrates of aluminum alloys, including 2024-T3 bare, 2024-T3 clad, and 7075-T6 bare aluminum alloys. The adhesive bonding primer uses is a one component epoxy based organic film, yellow in color. In Example 1, the adhesive bonding primer contains hexavalent chromium while in Example 2 which contains no hexavalent chromium, does contain a yellow dye. In the present examples, a yellow dye is selected to match the appearance standard of the chromium containing primer formulation. In other examples, dyes of other colors may be selected, depending on the application and target appearance of the bond primer formulation. It should be noted that any color of dye can be selected that can be detected by the colorimeter and correlated to coating thickness by the methods as described herein.

Each aluminum alloy substrate was treated with a phosphoric acid to provide an anodization surface preparation. In examples, the treatment of substrate can include exposure to phosphoric acid to anodize the surface of the metal. The anodization of the aluminum creates a pore structure on the aluminum surface that the primer then “fills in,” creating a strong interface between the primer and metal, providing a mechanism of adhesion. The method of anodization can be adjusted based on the substrate, bond primer and adhesive used in the bonded joint and target application. These adjustments include a variation in the anodization process parameters and/or the chemistry of the anodization solution including boric sulfuric acid anodize, tartaric sulfuric acid anodize and/or phosphoric sulfuric acid anodize. The substrate was then coated with various thicknesses of adhesive bonding primer applied by spray or foam applicator. If the primer was applied with a foam applicator the primer was heated to 140° F. briefly between applications to achieve the target film build thickness prior to a final bake. In examples, the first coat of primer can be heated to a temperature range of from about 130° F. to about 150° F. for about 1 sec to 10 sec, a second coat applied and heated from about 130° F. to about 150° F. for about 1 sec to 10 seconds and then a final coating applied and the primer baked from about 240° F. to about 260° F. for 30 seconds to 120 minutes to enable building to an appropriate target thickness and full cure. In other examples, adhesive bonding primer can be spray applied and cured by baking in an oven at 250° F. for 1 hour after application for a final bake.

The thickness of the primer was verified using an isoscope measurement, which provides an independent measurement of thickness using an eddy current measurement, which is based on electromagnetic induction employed to detect a distance between a sensor and the conducting substrate. A suitable instrument used is one such as a Fischer Dualscope with an FD10 probe.

Colorimetric analysis panels were generated by creating a ladder panel by masking the panel less and less with each successive build layer and applying more bond primer to build more and more film thickness with each successive pass. After curing, the color of each evaluation panel was measured with a BYK Gardner spectro-guide 45/0 gloss Model CC-6801. Bonded panels were assembled from 0.02″ thick and 0.04″ thick adherends. A 250° F. cure film adhesive was placed between the adherends, and the assembly autoclave cured at 250° F. Color analysis of data collected from the ladder panels, as presented in FIG. 3, demonstrates that the b* value, an indication of the yellow-blue scale, shows a correlation to bond primer thickness. Color b* values shown in FIG. 3 for both Example 1 and Example 2 exhibited a correlation coefficient of greater than 0.97 with a third order polynomial fit line. Climbing drum peel coupons used in testing described in the present disclosure were prepared by trimming out of the bonded assembly and testing in accordance with ASTM C 1781. Bond primer thickness can be measured on the ends of the coupons and correlated to peels strength.

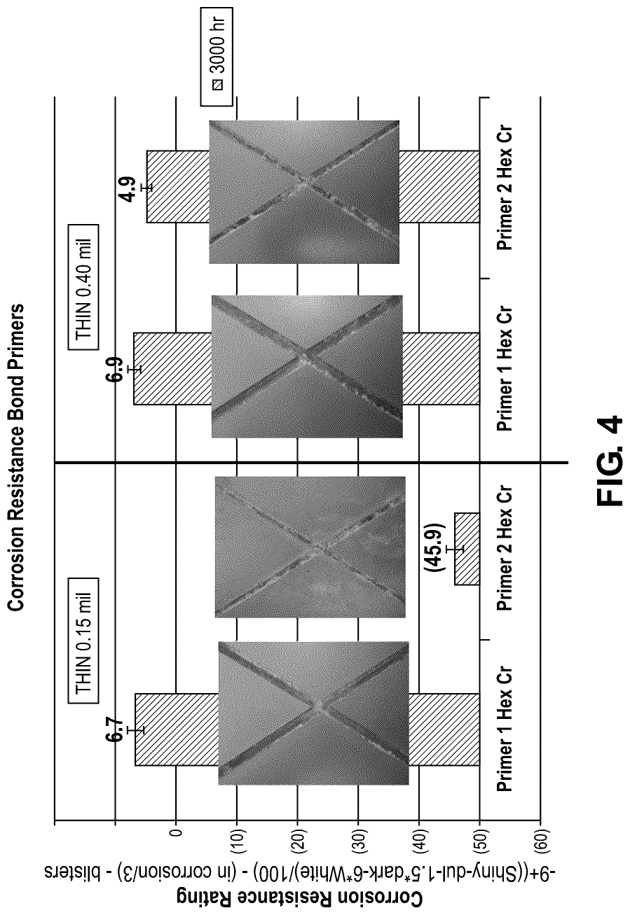

FIG. 4 is a plot depicting corrosion resistance rating as a function of primer type and primer thickness, in accordance with the present disclosure. FIG. 4 also shows the appearance of corrosion test panels of for thin samples (0.15 mil) and thick samples (0.40 mil) for both Example 1 (with hexavalent chromium) and Example 2 (chromium free). For examples herein, thickness ranges from about 0.1 mil to about 0.50 mil, or from about 0.05 mil to about 0.40 mil, or from about 0.15 mil to about 0.40 mil can be an applicable thickness range. The corrosion test panels were scribed with a 0.06″ wide scribe, corner to corner in an X pattern using a scribe machine, also referred to as an engraving machine. Corrosion panels were then exposed to 3000 hours of neutral salt fog in accordance with ASTM B 177. The panels were evaluated for any corrosion present in the scribe and outside the scribe using the following formula:

$$9 + ( ( shiny - dull - 1.5 * dark - 6 * white ) / 100 ) - ( in corrosion beyond scribe / 3 ) - blisters$$

Corrosion resistance results demonstrated that with increased bond primer thickness, there was a greater corrosion resistance, specifically in the case of Example 2 (Cr free bond primer.

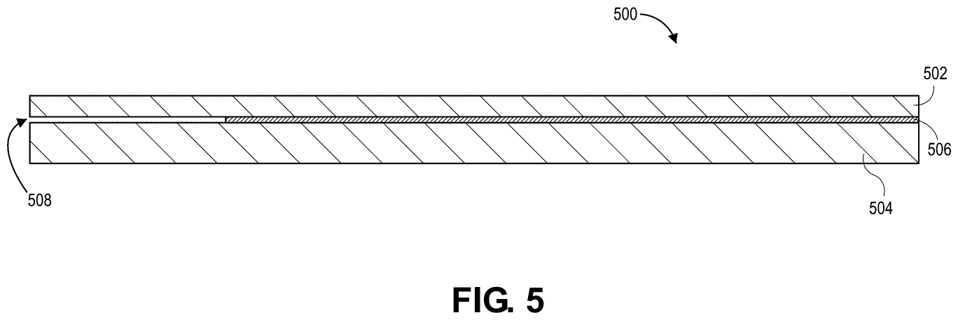

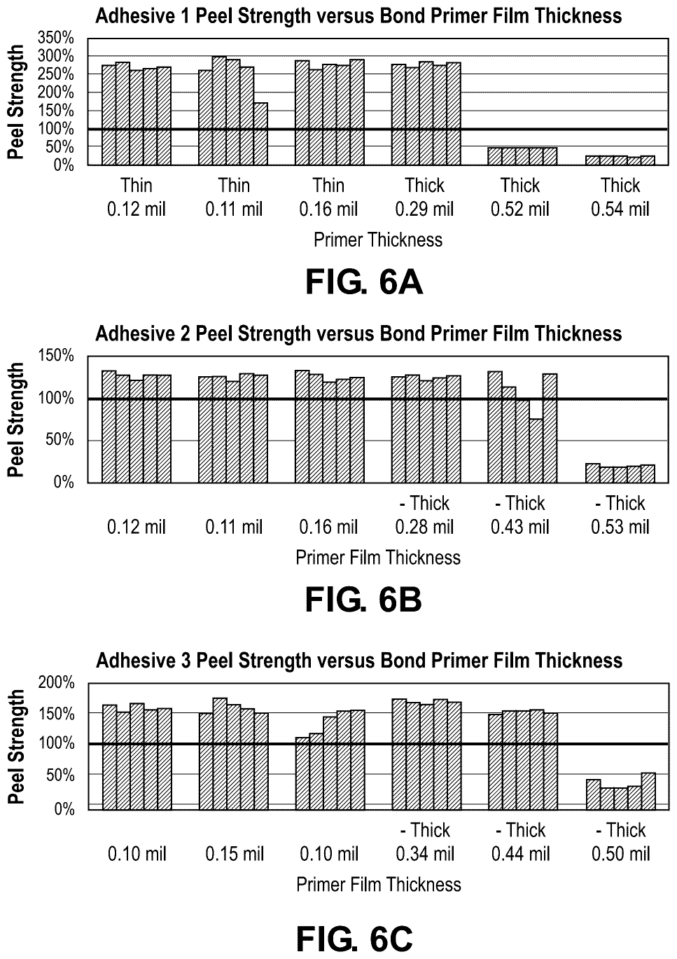

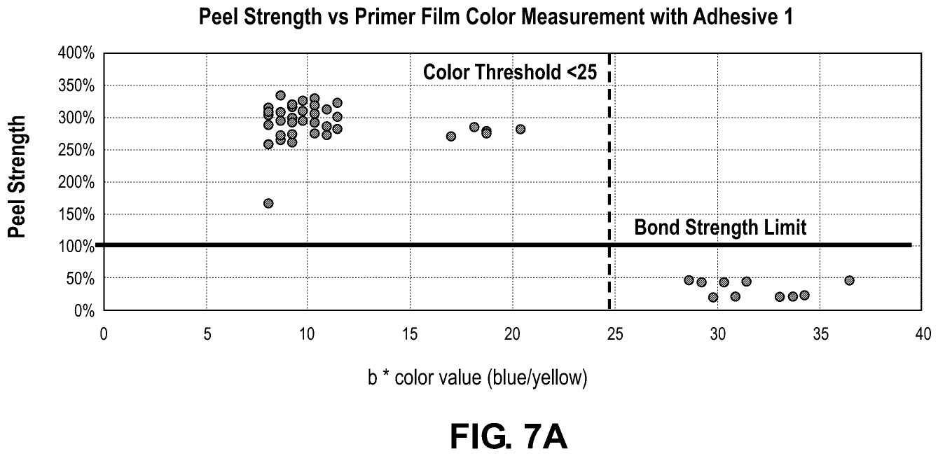

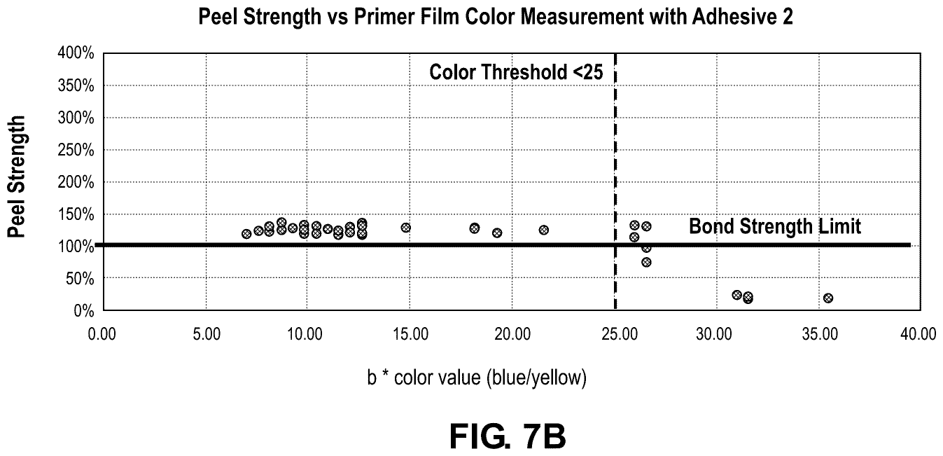

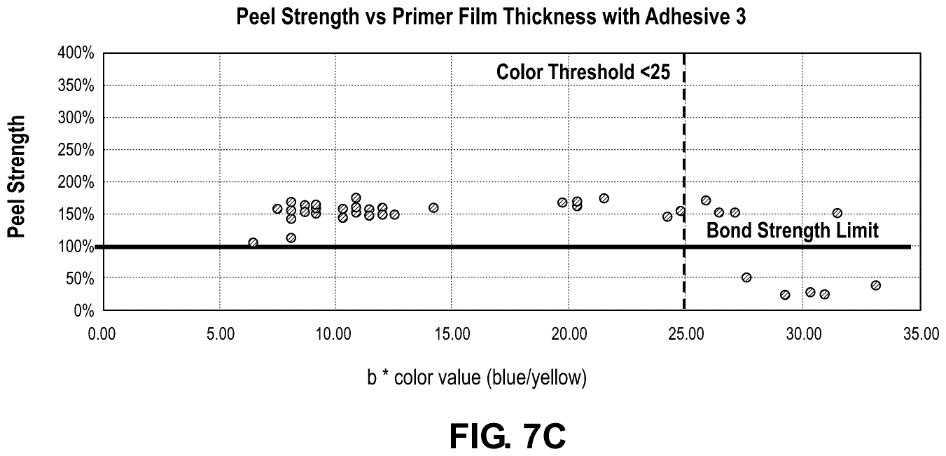

Peel strength was evaluated using methods in ASTM D 1781, as shown in a schematic in FIG. 5. A bonded climbing drum peel coupon 500 is shown in FIG. 5. An upper 502 and lower 504 aluminum coupon bonded using a 10 mil thick, 0.06 pcf film adhesive layer 506 in an autoclave at 250F for 90 min at 100 psi. An approximate 2 inch unbonded crack starter region 508 was left with no adhesive layer 506 applied. FIGS. 6A-6C, is a series of plots depicting a correlation between bond strength rating and primer thickness, in accordance with the present disclosure. FIGS. 6A-6C include data for three trials of adhesive peel strength measurements at a variety of bond primer thicknesses for Example 2 (chromium free bond primer). The general trend of the data in the three trials demonstrates an acceptable adhesive peel strength measurement across the specified thickness range, up to 0.40 mil, showing a correlation between bond strength rating and primer thickness. The acceptable threshold for peel strength adhesion is designated by the horizontal line at the 100% value on each of the plots shown in FIGS. 7A-7C. At thicknesses of primer that are exceeding the thickness threshold of 0.40 mil there is a reduction in peel strength performance.

FIGS. 7A-7C, is a series of plots depicting a correlation between b* color value of chromium free bond primer and bond peel strength value with three different adhesives, in accordance with the present disclosure. FIGS. 7A-7C include data for three trials of adhesive peel strength measurements as a function of b* color value of Example 2 (chromium free bond primer). In each plot, the upper left quadrant indicates data in an acceptable range for above 100% for adhesive peel strength while still below the acceptable color threshold below a value of 25 for b* color value. It should be noted that below 100% adhesive peel strength is a failure, as is above a color threshold value of 25. For the three different adhesives tested in the data shown in FIGS. 7A-7C, respectively, there are many acceptable test results, which can be detected using the colorimetric method as described herein. The peel strength results were demonstrated with three different epoxy film adhesives that are typically used in the aerospace industry.

As shown and described herein, the color values determined by the color spectrophotometer correlate to the bond primer thickness, bond performance, and corrosion resistance. This demonstrates that these tools enable detection of corrosion inhibition of structural adhesive bond primers and the ability to measure the corrosion resistance properties of the bond primer. The color surface analysis tool, specifically using the b* CIE color scheme value, can be used for verification of bond primer thickness, corrosion inhibition and bond performance. This enables a more robust, reliable and stable structural bonding process to support the fabrication of aerospace components.

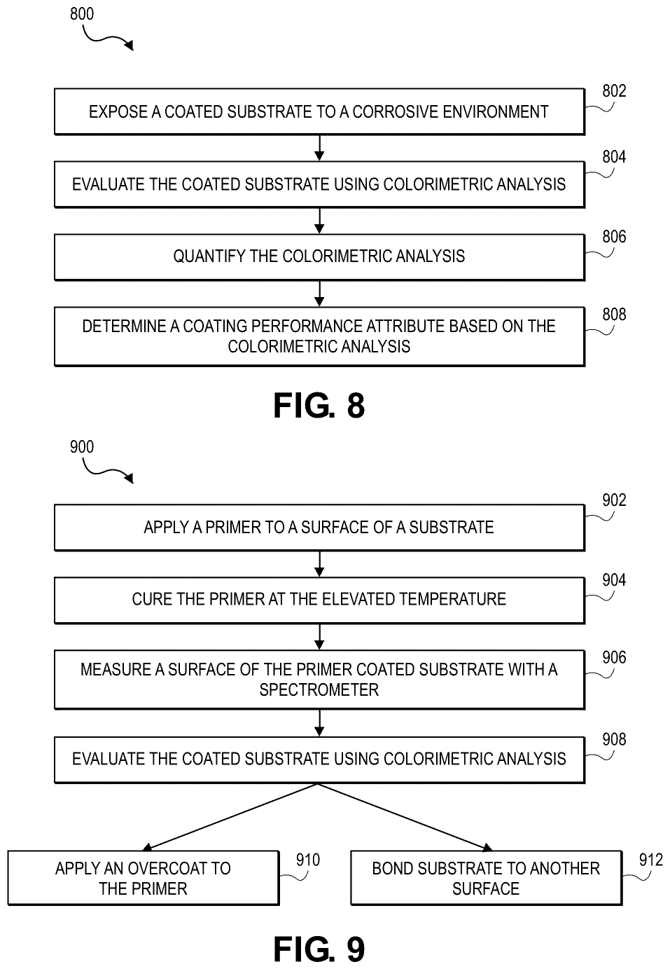

FIG. 8 is a flowchart illustrating a method for measuring performance of a film coated onto a substrate, in accordance with the present disclosure. A method for measuring performance of a film coated onto a substrate 800 can include exposing a coated substrate to a corrosive environment 802, followed by evaluating the coated substrate using colorimetric analysis 804, quantifying the colorimetric analysis 806, and determining a coating performance attribute based on the colorimetric analysis 808. The coating performance attribute can be bond primer thickness, bond performance, corrosion resistance, or a combination thereof. The method 800 can include where the corrosive environment comprises salt and moisture. In examples, the method 800 can include where a coating comprises an epoxy-functional paint or resin or where the substrate includes a metal. In examples of the present disclosure, the colorimetric analysis can include the use of an L*a*b* color scale. In some examples, the method 800 includes treating the substrate prior to coating the substrate using a process such as an anodization process. Further treatment of the substrate can include applying a primer comprising an epoxy, in some examples, in a thickness range of primer from 0.15 mil to 0.4 mil. The method 800 can include a primer containing hexavalent chromium, a dye, or other additive.

FIG. 9 is a flowchart illustrating a method of applying a coating to a substrate, in accordance with the present disclosure. The method of applying a coating to a substrate 900 includes applying a primer to a surface of a substrate 902, curing the primer at an elevated temperature 904, measuring a surface of the primer coated substrate with a spectrometer 906, evaluating the coated substrate using colorimetric analysis 908, and applying an overcoat onto the primer 910 or, in alternative examples, bonding a substrate having a primer applied to another surface 912. The other surface can be a similarly prepared and coated substrate, as depicted in FIG. 1. In examples, the method 900 can include exposing the coated substrate to a corrosive environment for testing or evaluation, quantifying the colorimetric analysis in a manner that enables the determination of one or more coating performance attributes based on the colorimetric analysis. The method 900 can, in other examples, include applying a thickness of primer in a range of from 0.1 mil to 0.5 mil, or where the overcoat includes an epoxy-functional paint or resin, or where the substrate comprises a metal. In some examples, the colorimetric analysis used in the method can involve the use of an L*a*b* color scale. In still other examples, the method of applying a coating to a substrate 900 can include anodizing the substrate prior to applying the primer to the substrate, or where the primer includes hexavalent chromium, a dye, or a combination thereof. It should be noted that steps described in regard to any of the methods or procedures can, in certain examples, be conducted or completed in any particular order, or repeated individually, in entirety, or in blocks of steps, as needed for any given application.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method for measuring performance of a film coated onto a substrate, comprising:
exposing a coated substrate to a corrosive environment;
evaluating the coated substrate using colorimetric analysis;
quantifying the colorimetric analysis; and
determining a coating performance attributes, corrosion resistance and bond strength, based on the colorimetric analysis.

2. The method for measuring performance of a film coated onto a substrate of claim 1, wherein the corrosive environment comprises salt and moisture.

3. The method for measuring performance of a film coated onto a substrate of claim 1, wherein the coating comprises an epoxy-functional paint or resin.

4. The method for measuring performance of a film coated onto a substrate of claim 1, wherein the substrate comprises a metal.

5. The method for measuring performance of a film coated onto a substrate of claim 1, wherein the colorimetric analysis comprises the use of an L*a*b* color scale.

6. The method for measuring performance of a film coated onto a substrate of claim 1, further comprising treating the substrate prior to coating the substrate.

7. The method for measuring performance of a film coated onto a substrate of claim 6, wherein treating the substrate comprises an anodization process.

8. The method for measuring performance of a film coated onto a substrate of claim 6, wherein treating the substrate comprises applying a primer comprising an epoxy.

9. The method for measuring performance of a film coated onto a substrate of claim 8, wherein a thickness range of primer is from 0.1 mil to 0.5 mil.

10. The method for measuring performance of a film coated onto a substrate of claim 8, wherein the primer comprises hexavalent chromium.

11. The method for measuring performance of a film coated onto a substrate of claim 8, wherein the primer comprises a dye.

12. The method for measuring performance of a film coated onto a substrate of claim 1, wherein the coating comprises an epoxy-functional paint or resin.

13. A method of applying a coating to a substrate, comprising:
applying a primer to a surface of a substrate;
curing the primer at an elevated temperature;
measuring a surface of the primer coated substrate with a spectrometer; and
evaluating the coated substrate using colorimetric analysis.

14. The method of applying a coating to a substrate of claim 13, further comprising applying an overcoat onto the primer.

15. The method of applying a coating to a substrate of claim 13, further comprising bonding a substrate having a primer applied to another surface.

16. The method of applying a coating to a substrate of claim 13, further comprising exposing the coated substrate to a corrosive environment.

17. The method of applying a coating to a substrate of claim 13, further comprising:
quantifying the colorimetric analysis; and
determining a coating performance attribute based on the colorimetric analysis.

18. The method of applying a coating to a substrate of claim 13, wherein a thickness range of primer is from 0.1 mil to 0.5 mil.

19. The method of applying a coating to a substrate of claim 13, wherein the overcoat comprises an epoxy-functional paint or resin.

20. The method of applying a coating to a substrate of claim 17, wherein the colorimetric analysis comprises the use of an L*a*b* color scale.
